(19) United States
(12) Patent Application Publication
(10) Pub. No.: US 2024/0010072 A1
(43) Pub. Date: Jan. 11, 2024

(54) RELAY SWITCHING CONTROL DEVICE, RELAY SWITCHING METHOD, STORAGE MEDIUM, AND VEHICLE

(71) Applicant: TOYOTA JIDOSHA KABUSHIKI KAISHA, Toyota-shi (JP)

(72) Inventor: Naoki MAEDA, Nisshin-shi (JP)

(73) Assignee: TOYOTA JIDOSHA KABUSHIKI KAISHA, Toyota-shi (JP)

(21) Appl. No.: 18/303,066

(22) Filed: Apr. 19, 2023

(30) Foreign Application Priority Data
Jul. 8, 2022 (JP) 2022-110476

(51) Int. Cl. B60L 3/00; H02J 3/38; B60L 50/64; B60L 3/04

(52) U.S. Cl. CPC B60L 3/0084; H02J 3/381; B60L 50/64; B60L 3/04; B60L 2210/10; H02J 2300/22

(57) ABSTRACT

When the power source and the electric device are required to be conductive, on condition that the elapsed time from output of the signal for making the positive electrode relay conductive is a predetermined time or more, the positive electrode advance control for outputting a signal for making the negative electrode relay conductive, and the power source and the electric device conductive are required, on condition that the elapsed time from output of the signal for placing the negative electrode relay in the conductive state is the predetermined time or more, the negative electrode advance control for outputting a signal for making the positive electrode relay conductive is configured to be executable, and when the number of times for making the power source and the electric device conductive is a predetermined number of times or more, the positive electrode preceding control and the negative electrode preceding control are switched.

### CROSS-REFERENCE TO RELATED APPLICATION

This application claims priority to Japanese Patent Application No. 2022-110476 filed on Jul. 8, 2022, incorporated herein by reference in its entirety.

### BACKGROUND

### 1. Technical Field

The present disclosure relates to a relay switching control device, a relay switching method, a storage medium, and a vehicle capable of electrically connecting and cutting off a power source and an electric device.

### 2. Description of Related Art

Japanese Unexamined Patent Application Publication No. 2012-186980 (JP 2012-186980 A) describes an electric circuit including a relay capable of cutting off an electric wire that connects a charging device and a power storage device. The charging device is connected to a positive electrode of the power storage device via a high-voltage electric wire and a bypass electric wire arranged in parallel with the high-voltage electric wire. The charging device is directly connected to a negative electrode of the power storage device. The high-voltage electric wire is provided with a first contact relay. The bypass electric wire is connected to the high-voltage electric wire while bypassing the first contact relay. Further, the bypass electric wire is configured by connecting a precharge relay and a precharge resistor in series. A configuration is adopted in which, when the power storage device is charged, the precharge relay is switched to ON first, and the first contact relay is switched to ON at the time when the capacitor provided in the charging device is sufficiently charged.

Japanese Unexamined Patent Application Publication No. 2012-005173 (JP 2012-005173 A) describes a control device for an electric circuit in which two batteries are connected in parallel to a power control unit (hereinafter referred to as a PCU). The electric circuit includes a capacitor of a charging device connected between the batteries and two relays provided between the capacitor and each of the batteries so as to suppress a short circuit in the case where a voltage difference between the two batteries is large. In order to equalize the voltages of the two batteries, the control device is configured to switch the relay on one negative electrode side to ON and switch the relay on the other negative electrode side to OFF while the relay on each of the positive electrode sides is maintained to be ON, and then switch the relay on one negative electrode side to OFF, and then, switch the relay on the other negative electrode side to ON and switch the relay on the other negative electrode side to ON, when a period during which the voltage difference between the two batteries is equal to or more than a predetermined difference continues for a predetermined period or longer. Further, the configuration is adopted in which, when a predetermined cycle has elapsed, the relays on the negative electrode sides are maintained to be ON, the relay on one positive electrode side is switched to ON, the relay on the other positive electrode side is switched to OFF, and then the relay on the one positive electrode side is switched to OFF, and the relay on the other positive electrode side is switched to ON.

Japanese Unexamined Patent Application Publication No. 2020-043737 (JP 2020-043737 A) describes a control device that precharges a smoothing capacitor provided in a PCU in an electric circuit in which a power storage device and the PCU are connected via a system main relay (hereinafter, referred to as a SMR). The control device is configured to execute duty control to alternately switch the positive electrode side of the SMR and the negative electrode side of the SMR between ON and OFF when the smoothing capacitor is precharged from a state where the SMR is off. Specifically, the configuration is adopted in which a series of operations to switch the positive electrode side of the SMR to ON, switch the negative electrode side of the SMR to ON in this state, and after that, switch the positive electrode side of the SMR to OFF while the negative electrode side of the SMR is maintained in the ON state, and further, after that, switch the negative electrode side of the SMR to OFF while the positive electrode side of the SMR is maintained in the OFF state is repeatedly executed.

### SUMMARY

In the electric circuit described in JP 2012-186980 A, the precharge resistor and the precharge relay are connected, and therefore the current flowing at the time when the precharge relay is switched to ON can be reduced, and arc discharge can be suppressed from occurring immediately before the precharge relay is placed in the conductive state. On the other hand, when such a precharge relay is provided, the electric circuit becomes large in size, and switching between the precharge relay and the first contact relay is required, which may complicate the control.

Further, the control device described in JP 2012-005173 A is configured to, while one of the relays on the positive electrode side and the negative electrode side is maintained in the conductive state, switch the conductive state and the non-conductive state of the other relay in order to suppress the control for switching placing one of the batteries and the capacitor in the conductive state and placing the other battery and the capacitor in the conductive state from becoming complicated. However, the control device described in JP 2012-005173 A switches, when the condition for executing equalization control is satisfied, the relay on the positive electrode side and the relay on the negative electrode side provided between one of the batteries and the capacitor to the conductive state so as to place the one battery and the capacitor in the conductive state. In this case, due to the individual difference between the relay on the positive electrode side and the relay on the negative electrode side, the relay on one side is placed in the conductive state with a delay from the relay on the other side, and arc discharge may occur immediately before the relay on the one side is placed in the conductive state. Since the relay that is placed in the conductive state with a delay as described above is also placed in the conductive state with a delay in a similar manner when one of the batteries in which the equalization control is executed and the capacitor are placed in the conductive state again, the relay in which arc discharge occurs is limited to the same relay, whereby the durability may deteriorate at an early stage. Therefore, the durability of the entire relay provided between one of the batteries and the capacitor depends on the relay with a lower durability of the relay on the positive electrode side and the relay on the negative electrode side, whereby the durability of the entire relay may deteriorate at an early stage.

Furthermore, the control device described in JP 2020-043737 A is configured to execute duty control for precharging the smoothing capacitor. However, in this control, the positive electrode side of the SMR is placed in an energized state at all times at the time point at which the negative electrode side of the SMR is switched to the conductive state. Therefore, arc discharge occurs on the negative electrode side of the SMR every time the negative electrode side of the SMR is placed in the conductive state, which may deteriorate and the durability of the negative electrode side of the SMR earlier than the durability of the positive electrode side of the SMR. The durability of the entire SMR depends on the side with a lower durability of the positive electrode side and the negative electrode side of the SMR, whereby the durability of the entire SMR may deteriorate at an early stage.

The present disclosure has been made focusing on the technical issues above, and an object thereof is to provide a relay switching control device, a relay switching method, a storage medium, and a vehicle capable of improving a durability of the relay while an increase in size of an electric circuit is suppressed.

A relay switching control device according to a first aspect of the present disclosure includes: a power source; an electric device to which power is supplied from the power source or that supplies power to the power source; a positive electrode electric wire that connects a positive electrode of the power source and the electric device; a negative electrode electric wire that connects a negative electrode of the power source and the electric device; a positive electrode relay that is able to selectively cut off the positive electrode electric wire; a negative electrode relay that is able to selectively cut off the negative electrode electric wire; and a controller that is provided with a switching unit and controls the positive electrode relay and the negative electrode relay.

The controller is configured to execute a positive electrode advance control that outputs a signal to place the negative electrode relay in a conductive state on condition that an elapsed time after a signal to place the positive electrode relay in the conductive state is output is equal to or more than a predetermined time that is determined in advance or the positive electrode relay is detected to be placed in the conductive state, when the power source and the electric device are required to be placed in the conductive state.
The controller is configured to execute a negative electrode advance control that outputs the signal to place the positive electrode relay in the conductive state on condition that an elapsed time after the signal to place the negative electrode relay in the conductive state is output is equal to or more than the predetermined time or the negative electrode relay is detected to be placed in the conductive state, when the power source and the electric device are required to be placed in the conductive state.
The controller is configured to switch between the positive electrode advance control and the negative electrode advance control by the switching unit when the number of times that the power source and the electric device are placed in the conductive state is equal to or more than a predetermined number of times.
In the relay switching control device according to the first aspect above, the predetermined time may be set to a time to be equal to or more than a difference between a time point at which the positive electrode relay is placed in the conductive state and a time point at which the negative electrode relay is placed in the conductive state when the signal to place the positive electrode relay in the conductive state and the signal to place the negative electrode relay in the conductive state are simultaneously output.

In the relay switching control device according to the first aspect above, the electric device may include a charging device.

In the relay switching control device according to the first aspect above, the charging device may include a solar generator.

A relay switching method according to a second aspect of the present disclosure is a relay switching method of switching a conductive state and a non-conductive state of each of a positive electrode relay that is able to selectively cut off a positive electrode electric wire connecting a positive electrode of a power source and an electric device and a negative electrode relay that is able to selectively cut off a negative electrode electric wire connecting a negative electrode of the power source and the electric device. The relay switching method includes: switching one relay from the positive electrode relay and the negative electrode relay to the conductive state when the power source and the electric device are required to be placed in the conductive state; placing the power source and the electric device in the conductive state by switching the other relay from the positive electrode relay and the negative electrode relay to the conductive state after a predetermined time elapses from a start of switching the one relay to the conductive state or after the one relay is placed in the conductive state; switching the other relay to the conductive state when the power source and the electric device are again required to be placed in the conductive state; and placing the power source and the electric device in the conductive state by switching the one relay to the conductive state after a predetermined time elapses from a start of switching the other relay to the conductive state or after the other relay is placed in the conductive state.

A storage medium according to a third aspect of the present disclosure stores a relay switching program that causes each of a positive electrode relay that is able to selectively cut off a positive electrode electric wire connecting a positive electrode of a power source and an electric device and a negative electrode relay that is able to selectively cut off a negative electrode electric wire connecting a negative electrode of the power source and the electric device to be switched from a non-conductive state to a conductive state. The relay switching program includes: causing one relay from the positive electrode relay and the negative electrode relay to be switched to the conductive state when the power source and the electric device are required to be placed in the conductive state; causing the power source and the electric device to be electrically connected to each other by causing the other relay from the positive electrode relay and the negative electrode relay to be switched to the conductive state after a predetermined time elapses from a start of causing the one relay to be switched to the conductive state or after the one relay is placed in the conductive state; causing the other relay to be switched to the conductive state when the power source and the electric device are again required to be placed in the conductive state; and causing the power source and the electric device to be electrically connected to each other by causing the one relay to be switched to the conductive state after a predetermined time lapses from a start of causing the other relay to be switched to the conductive state or after the other relay is placed in the conductive state.

A vehicle according to a fourth aspect of the present disclosure is a vehicle equipped with the relay switching control device above.

According to the present disclosure, when the power source and the electric device are required to be in the conductive state, the signal to place one relay from the relay on the positive electrode side and the relay on the negative electrode side in the conductive state is output, and after that, the signal to place the other relay in the conductive state is output. Therefore, arc discharge occurs in the relay for which the signal is output with a delay. That is, even when there is a processing error or an assembly error, and there is a difference in the time from the output of the signal to place the relay in the conductive state until the relay is placed in the conductive state, it is possible to select the relay in which arc discharge occurs. When the number of times that the power source and the electric device are placed in the conductive state becomes equal to or more than the predetermined number of times, the relay for which the signal to place the relay in the conductive state in advance is output is switched. Therefore, it is possible to suppress a situation in which arc discharge occurs only in one of the relays by switching the relay to be placed in the conductive state in advance in accordance with the number of times that the power source and the electric device are required to be electrically connected to each other. Therefore, it is possible to suppress that only the durability of one of the relays deteriorates at an early stage, and thus it is possible to extend the life of the entire relay. Further, since it is possible to extend the life of the entire relay by controlling the timing to place the relay in the conductive state as described above, there is no need to provide an electrical resistance member or a diode for reducing the current flowing through the relay, and it is possible to suppress the control from becoming complicated, in addition to downsizing and simplification of the electric circuit.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram for explaining an example of an electric circuit including a positive electrode relay and a negative electrode relay according to an embodiment of the present disclosure;

FIG. 2 is a flow chart for explaining an exemplary control executed by the switching control device according to the embodiment.

### DETAILED DESCRIPTION OF EMBODIMENTS

The present disclosure will be described with reference to the embodiments shown in the drawings. Note that the embodiments described below are merely examples of a case where the present disclosure is embodied. Therefore, the embodiments described below are not intended to limit the present disclosure.

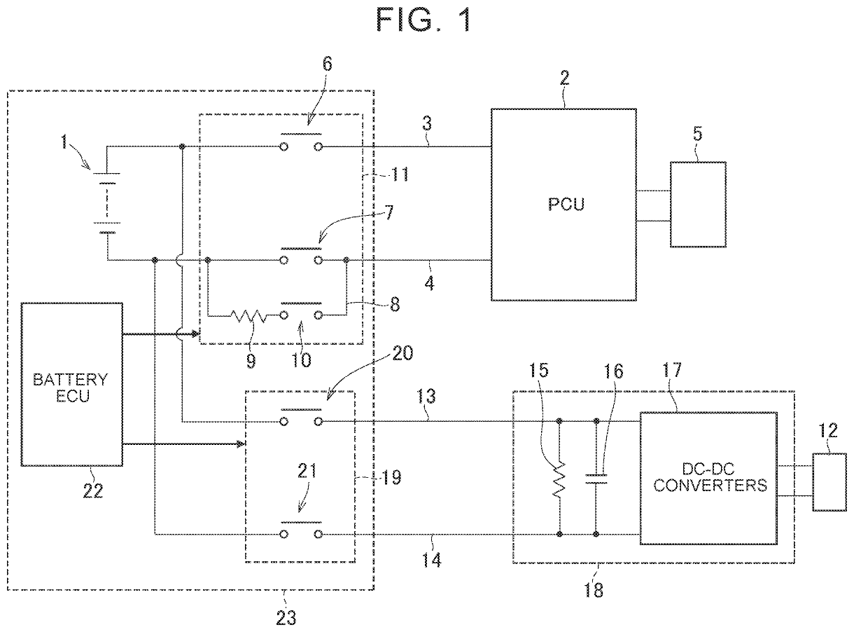

FIG. 1 is a block diagram for explaining an example of an electric circuit including a positive electrode relay and a negative electrode relay according to an embodiment of the present disclosure. In the example shown in FIG. 1, the electric circuit includes a power storage device 1. The power storage device 1 supplies electric power to a motor (not shown) that functions as a driving force source of the vehicle. The power storage device 1 is supplied with electric power generated by a motor. The power storage device 1 corresponds to a “power source” in the embodiment of the present disclosure.

The power storage device 1 can be configured similarly to a power storage device that exchanges electric power with a motor mounted on a conventional battery electric vehicle or hybrid electric vehicle, and is configured by connecting a plurality of secondary batteries such as a lithium-ion battery in series, for example.

A power control unit (hereinafter, referred to as a PCU) 2 is connected to the power storage device 1. That is, the driving positive electrode electric wire 3 connected to the positive electrode of the power storage device 1 and the driving negative electrode electric wire 4 connected to the negative electrode of the power storage device 1 are connected in PCU 2. This PCU 2 is composed of inverters, relatively large-capacity capacitors, and the like. The inverter converts the DC power charged in the power storage device 1 into AC power and outputs the AC power to the motor 5. The inverter converts AC power generated by the motor 5 into DC power and outputs the DC power to the power storage device 1.

The positive electrode electric wire 3 for driving is provided with a positive electrode-side system main relay (hereinafter referred to as SMR-B) 6 capable of selectively disconnecting the positive electrode of the power storage device 1 from PCU 2. Similarly, the driving negative electrode electric wire 4 is provided with a negative electrode-side system main relay (hereinafter referred to as SMR-G) 7 that can selectively shut off the negative electrode of the power storage device 1 from being connected to PCU 2.

A bypass electric wire 8 connected to SMR-G 7 power storage device 1 and PCU 2 is connected to the driving negative electrode electric wire 4. The bypass electric wire 8 is provided with an electrical resistance member 9 provided on the electric storage device 1 and a precharge system main relay (hereinafter referred to as SMR-P) 10 capable of selectively shutting off the bypass electric wire 8 connected in series.

These SMR-B 6, SMR-G 7 and SMR-P 10 are configured in the same manner as conventional relays, and are configured such that, for example, by energizing a solenoid (not shown), a movable member made of a magnetic material is moved by the electromagnetic force to close the contact (to be placed in a conductive state). That is, when SMR-B 6 and SMR-G 7 or SMR-P 10 are placed in the conductive state, the power storage device 1 and PCU 2 are brought into conduction. Therefore, by controlling PCU 2, a desired electric power can be supplied to the motor 5. In the following explanation, the relay block constituted by SMR-B 6, SMR-G 7, SMR-P 10 and the electrical resistance member 9 is referred to as a SMR block 11.

In addition, a solar generator (solar panel) 12 for charging the power storage device 1 is connected. Specifically, a charging positive electrode electric wire 13 connected between the power storage device 1 and SMR-B 6 in the driving positive electrode electric wire 3, a charging negative electrode electric wire 14 connected between the power storage device 1 and SMR-G 7 in the driving negative electrode electric wire 4, and a portion where the power storage device 1 and the bypass electric wire 8 are connected are connected to the solar panel 12. Note that the solar panel 12 corresponds to an “electric device” in the embodiment of the present disclosure, the charging positive electrode electric wire 13 corresponds to a “positive electrode electric wire” in the embodiment of the present disclosure, and the charging negative electrode electric wire 14 corresponds to a “negative electrode electric wire” in the embodiment of the present disclosure.

An electrical resistance member 15, a capacitor 16 having a relatively small capacitance, and a DC-DC converter 17 are connected in parallel with the solar panel 12 to the charging positive electrode electric wire 13 and the charging negative electrode electric wire 14. The electrical resistance member 15, the capacitor 16, and DC-DC converters 17 are integrated as a single electronic control unit (hereinafter, referred to as a solar ECU) 18 and mounted on vehicles. The solar ECU 18 is configured to boost the electric power generated by the solar panel 12 and charge the power storage device 1.

A CHR block 19 is provided which is capable of making the power storage device 1 and the solar ECU 18 conductive or blocking the conductive state thereof. CHR block 19 is configured to be in the conductive state, for example, when the power generated by the solar panel 12 is equal to or higher than a predetermined power at the time of stopping or stopping. Specifically, a positive-electrode-side charging relay (hereinafter referred to as “CHR-B”) 20 is provided between the positive electrode of the power storage device 1 and the solar ECU18, and similarly, a negative-electrode-side charging relay (hereinafter referred to as “CHR-G”) 21 is provided between the negative electrode of the power storage device 1 and the solar ECU18. In the embodiment shown in FIG. 1, there are no wires that bypass CHR-G 21 and no relays that shut off the wires. Note that CHR-B 20 corresponds to the “positive electrode relay” in the embodiment of the present disclosure, and CHR-G 21 corresponds to the “negative electrode relay” in the embodiment of the present disclosure.

CHR-B 20 and CHR-G 21 are configured in the same manner as SMR-B 6, SMR-G 7 and SMR-P 10 described above, and are configured such that, for example, by energizing a solenoid (not shown), a movable member made of a magnetic material is moved by the electromagnetic force to close the contact (to be placed in the conductive state). That is, when CHR-B 20 and CHR-G 21 are brought into a conductive state, the power storage device 1 and the solar ECU 18 are brought into a conductive state, and by controlling the solar ECU 18, the power generated is supplied from the solar panel 12 to the power storage device 1.

An electronic control unit (hereinafter referred to as a cell ECU) 22 for controlling SMR block 11 and CHR block 19 described above is provided. This battery ECU 22 corresponds to a “controller” in the embodiment of the present disclosure, and is conventionally constituted mainly by a microcomputer, similar to an ECU provided in a vehicle. That is, a signal is inputted from various sensors provided in vehicles, and a signal outputted to SMR block 11 and CHR block 19 is outputted by executing a program stored in advance. More specifically, the battery ECU 22 is configured to execute a pre-stored program to individually output a signal to be brought into a conductive state or a signal to be brought into a non-conductive state to SMR-B 6, SMR-G 7, SMR-P 10, CHR-B 20 and CHR-G 21.

Examples of the signal inputted to the battery ECU 22 include signals such as the charge amount of the capacitor 16 detected by the solar ECU 18 (or the generated electric power of the solar panel 12), the demand for driving the motor 5 by a driving ECU (not shown), the charge amount of the capacitor provided in PCU 2, the remaining charge amount of the power storage device 1, the temperature of the power storage device 1, and the energization current of the power storage device 1.

The power storage device 1, SMR block 11, CHR block 19, and the battery ECU 22 are housed in one case 23 and mounted on vehicles.

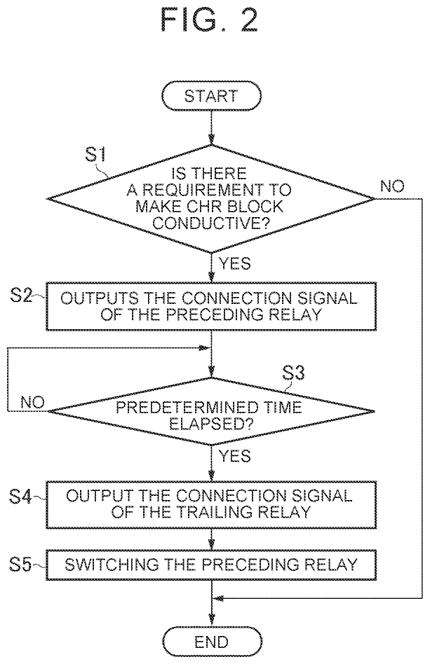

FIG. 2 is a flow chart for explaining an exemplary control performed by the battery ECU 22. In the control illustrated in FIG. 2, first, it is determined whether or not CHR block 19 is required to be in the conductive state, that is, the power storage device 1 and the solar panel 12 are required to be in conduction (step S1). The step S1 may determine whether or not the power storage device 1 is in a chargeable state on the basis of, for example, that the vehicle is stopped, that the remaining charge amount of the power storage device 1 is less than the predetermined upper limit remaining amount, that the power generated by the solar panel 12 is equal to or more than the predetermined power that is determined in advance, that the temperature of the power storage device 1 is within the predetermined range, and the like.

If a negative determination is made in S1 of steps due to the fact that CHR block 19 is not required to be in the conductive state, the routine is terminated once. In this case, for example, when there is a request to travel the vehicle and when the capacitor provided in PCU 2 is not charged, SMR-B 6 and SMR-P 10 are brought into a conductive state, or when there is a request to travel the vehicle and when the capacitor provided in PCU 2 is charged, SMR-B 6 and SMR-G 7 are brought into a conductive state, or when there is no request to charge the power storage device 1 while maintaining the stop state, SMR block 11 is brought into a non-conductive state.

If it is determined positively in the step S1 that CHR block 19 is required to be placed in the conductive state, a signal for connecting the preceding relay is outputted (step S2). In this step S2, the step S5 described later is executed, whereby one of CHR-B 20 and CHR-G 21 is selected as the preceding relay, and the selected preceding relay is placed in the conductive state. At the time of shipping, one of CHR-B 20 and CHR-G 21 is defined as a preceding relay.

Next, it is determined whether or not a predetermined period of time has elapsed since the output of the signal to which the preceding relay is connected (step S3). This step S3 is a step for determining whether or not a period from when a signal for bringing the relay into a conductive state is outputted to the preceding relay until when the relay is brought into a conductive state has elapsed. That is, whether or not the preceding relay is in the conductive state is determined by the elapsed time from the output of the signal. Therefore, the time difference between the time point at which CHR-B 20 is in the conductive state and the time point at which CHR-G 21 is in the conductive state can be determined in advance in view of the manufacturing error, the assembly error, and the like, and the predetermined time in the step S3 can be determined to be equal to or more than the above-described time difference, when the signal with CHR-B 20 in the conductive state and the signal with CHR-G 21 in the conductive state are simultaneously outputted.

If a negative determination is made in step S3 because a predetermined period of time has not elapsed since the outputting of the signal to which the preceding relay is connected, the step S3 is repeatedly executed. That is, it stands by until a predetermined time has elapsed since the output of the signal to which the preceding relay is connected. On the contrary, when it is determined affirmatively in the step S3 that a predetermined period has elapsed since the signal connecting the preceding relay is output, a signal connecting the subsequent relay is output (step S4). That is, the signal for connecting CHR-B 20 and the signal for connecting CHR-G 21 are shifted by a predetermined period.

Then, the relay that is connected to CHR-B 20 and CHR-G 21 at the step S4 is selected as the preceding relay (step S5), and the routine is terminated once. That is, the relay for outputting the signal to be connected in advance is switched.

When the control shown in FIG. 2 is described as a specific example, first, when CHR block 19 is required to be in a conductive state, a signal for connecting CHR-B as the preceding relay is output, and after a predetermined period elapses after the signal is output, a signal for connecting CHR-G 21 as the following relay is output. The control of outputting a signal for connecting the relay (CHR-B 20) on the positive electrode side to the relay (CHR-G 21) on the negative electrode side in this manner corresponds to the “positive electrode advance control” in the embodiment of the present disclosure.

Then, after outputting the signal to connect CHR-G 21, the preceding relay is switched from CHR-B 20 to CHR-G 21. This switching step corresponds to a “switching unit” in the embodiment of the present disclosure, in which the preceding relay is switched every trip. That is, one trip corresponds to a “predetermined number of times” in the embodiment of the present disclosure.

After the preceding relay is switched as described above, if it is requested that CHR block 19 be placed in the conductive state again, a signal for connecting CHR-G 21 as the preceding relay is output, and after a predetermined period elapses after the signal is output, a signal for connecting CHR-B 20 as the following relay is output. The control for outputting a signal for connecting the relay (CHR-G 21) on the negative electrode side to the relay (CHR-B 20) on the positive electrode side in this manner corresponds to the “negative electrode advance control” in the embodiment of the present disclosure.

As described above, in the case where the relay on the positive electrode side and the relay on the negative electrode side are brought into a conductive state, after a predetermined time has elapsed since a signal for bringing one of the relays into a conductive state is output, a signal for bringing the other relay into a conductive state is output, whereby arcing occurs in the relay in which the signal is output in a delayed manner. That is, even if there is a machining error or an assembly error, it is possible to select a relay in which an arc discharge occurs. Therefore, when there is a request for conduction between the power storage device 1 and the solar panel 12, by switching the relay to be placed in the conductive state in advance, it is possible to suppress a situation in which an arc discharge occurs only in one of the relays. Therefore, it is possible to prevent only the durability of one of the relays from decreasing at an early stage, and thus it is possible to extend the life of the entire relay.

Further, since it is possible to extend the life of the entire relay by controlling the timing to place the relay in the conductive state as described above, it is not necessary to provide an electrical resistance member or a diode for reducing the current flowing through the relay, in addition to the miniaturization and simplification of the electrical circuit, it is possible to suppress that the control becomes complicated. Further, since it is not necessary to provide an electric device such as a diode, it is possible to reduce the power loss in the process of supplying the power storage device 1 from the solar panel 12, and it is possible to improve the charging efficiency.

Note that the relay switching control device in the embodiment of the present disclosure may be configured to perform a plurality of trips of control for conducting one relay prior to the other relay, and then switch the other relay to control for conducting the other relay prior to the one relay. Further, in the example shown in FIG. 2, after a predetermined time has elapsed since the output of the signal for connecting the preceding relay, it is configured to output a signal for connecting the subsequent relay, when it is detected that the preceding relay is placed in the conductive state may be configured to output a signal for connecting the subsequent relay. Further, the electric device according to the embodiment of the present disclosure is not limited to the solar panel 12, and may be a charging device such as an external power source, or may be an electric apparatus that does not have a function of supplying power to the power storage device 1.

Although the embodiments of the present disclosure have been described above, the present disclosure can be regarded as not only a relay switching control device but also a relay switching method executed by the switching control device, a switching program of the method, a storage medium of a ECU storing the switching program, or vehicles equipped with a relay switching control device.

What is claimed is:

1. A relay switching control device comprising:
a power source;
an electric device to which power is supplied from the power source or that supplies power to the power source;
a positive electrode electric wire that connects a positive electrode of the power source and the electric device;
a negative electrode electric wire that connects a negative electrode of the power source and the electric device;
a positive electrode relay that is able to selectively cut off the positive electrode electric wire;
a negative electrode relay that is able to selectively cut off the negative electrode electric wire; and
a controller that is provided with a switching unit and controls the positive electrode relay and the negative electrode relay, wherein
the controller is configured to:
execute a positive electrode advance control that outputs a signal to place the negative electrode relay in a conductive state on condition that an elapsed time after a signal to place the positive electrode relay in the conductive state is output is equal to or more than a predetermined time that is determined in advance or the positive electrode relay is detected to be placed in the conductive state, when the power source and the electric device are required to be placed in the conductive state;
execute a negative electrode advance control that outputs the signal to place the positive electrode relay in the conductive state on condition that an elapsed time after the signal to place the negative electrode relay in the conductive state is output is equal to or more than the predetermined time or the negative electrode relay is detected to be placed in the conductive state when the power source and the electric device are required to be placed in the conductive state; and
switch between the positive electrode advance control and the negative electrode advance control by the switching unit when the number of times that the power source and the electric device are placed in the conductive state is equal to or more than a predetermined number of times.

2. The relay switching control device according to claim 1, wherein the predetermined time is set to a time to be equal to or more than a difference between a time point at which the positive electrode relay is placed in the conductive state and a time point at which the negative electrode relay is placed in the conductive state when the signal to place the positive electrode relay in the conductive state and the signal to place the negative electrode relay in the conductive state are simultaneously output.

3. The relay switching control device according to claim 1, wherein the electric device includes a charging device.

4. The relay switching control device according to claim 3, wherein the charging device includes a solar generator.

5. A relay switching method being a relay switching method of switching a conductive state and a non-conductive state of each of a positive electrode relay that is able to selectively cut off a positive electrode electric wire connecting a positive electrode of a power source and an electric device and a negative electrode relay that is able to selectively cut off a negative electrode electric wire connecting a negative electrode of the power source and the electric device, the relay switching method comprising:
switching one relay from the positive electrode relay and the negative electrode relay to the conductive state when the power source and the electric device are required to be placed in the conductive state;
placing the power source and the electric device in the conductive state by switching the other relay from the positive electrode relay and the negative electrode relay to the conductive state after a predetermined time elapses from a start of switching the one relay to the conductive state or after the one relay is placed in the conductive state;
switching the other relay to the conductive state when the power source and the electric device are again required to be placed in the conductive state; and
placing the power source and the electric device in the conductive state by switching the one relay to the conductive state after a predetermined time elapses from a start of switching the other relay to the conductive state or after the other relay is placed in the conductive state.

6. A non-transitory storage medium storing a relay switching program that causes each of a positive electrode relay that is able to selectively cut off a positive electrode electric wire connecting a positive electrode of a power source and an electric device and a negative electrode relay that is able to selectively cut off a negative electrode electric wire connecting a negative electrode of the power source and the electric device to be switched from a non-conductive state to a conductive state, wherein the relay switching program includes:
causing one relay from the positive electrode relay and the negative electrode relay to be switched to the conductive state when the power source and the electric device are required to be placed in the conductive state;
causing the power source and the electric device to be electrically connected to each other by causing the other relay from the positive electrode relay and the negative electrode relay to be switched to the conductive state after a predetermined time elapses from a start of causing the one relay to be switched to the conductive state or after the one relay is placed in the conductive state;
causing the other relay to be switched to the conductive state when the power source and the electric device are again required to be placed in the conductive state; and
causing the power source and the electric device to be electrically connected to each other by causing the one relay to be switched to the conductive state after a predetermined time lapses from a start of causing the other relay to be switched to the conductive state or after the other relay is placed in the conductive state.

7. A vehicle equipped with the relay switching control device according to claim 1.
